(19) United States
(12) Patent Application Publication
(10) Pub. No.: US 2014/0375627 A1
(43) Pub. Date: Dec. 25, 2014

(54) DISPLAY DEVICE AND DRIVING METHOD THEREOF

(71) Applicant: Samsung Display Co., Ltd., Yongin-City (KR)

(72) Inventors: Byung Sun Kim, Seoul (KR); Dae-Gwang Jang, Cheonan-si (KR); Seok Ha Hong, Yongin-si (KR)

(21) Appl. No.: 14/307,120

(22) Filed: Jun. 17, 2014

(30) Foreign Application Priority Data
Jun. 19, 2013 (KR) 10-2013-0070300

(51) Int. Cl. G09G 3/36

(52) U.S. Cl. CPC G09G 3/3674; G09G 2310/0267
USPC 345/214; 345/90

(57) ABSTRACT

A display device and driving method thereof are disclosed. In one aspect, the display device includes a display panel displaying a still image and a moving image and a signal control unit controlling signals for driving the display panel and controlling a frequency of the display panel based on a low frequency enable signal. The signal control unit controls the driving of the display panel at a low frequency when the still image is applied to the display panel and the driving of the display panel at a normal driving frequency after a first time elapses. The signal control unit further controls the driving of the display panel at a low frequency after a second time elapses.

### CROSS-REFERENCE TO RELATED APPLICATIONS

This application claims priority to and the benefit of Korean Patent Application No. 10-2013-0070300 filed in the Korean Intellectual Property Office on Jun. 19, 2013, the entire contents of which are incorporated herein by reference.

### BACKGROUND

1. Field

The described technology generally relates to a display device and a driving method thereof.

2. Description of the Related Technology

Many consumer electronic devices, such as computer monitors, televisions, mobile phones, and the like, require a display device. Examples of such a display device include a cathode ray tube display device, a liquid crystal display (LCD), a plasma display device, an organic light-emitting diode (OLED) display, and the like.

Display devices generally include a display panel and a signal control unit. The signal control unit typically generates control signals for driving the display panel and transmits the control signals to the display panel along with an image signal received from an external source to drive the display panel.

Images displayed on a display panel cab be categorized as still images and moving images. Display panels typically display several frames per second and in the case the image data of each frame is the same, the display panels display a still image. Further, when the image data of each frame is different, the display panels display a moving image.

For both still and moving images, the signal control unit receives image data from a graphic processing unit for each frame and thus may consume a considerable amount of power.

The above information disclosed in this Background section is only intended to facilitate the understanding of the background of the described technology and therefore it may contain information that does not constitute the prior art that is already known in this country to a person of ordinary skill in the art.

### SUMMARY OF CERTAIN INVENTIVE ASPECTS

One inventive aspect is a display device capable of preventing an afterimage phenomenon during low frequency driving or reducing a luminance flickering phenomenon in a frequency change period.

Another aspect is a display device, including a display panel displaying a still image and a moving image, and a signal control unit supplying signals for driving the display panel and controlling a frequency of the display panel based on a low frequency enable signal, in which the signal control unit controls i) the driving of the display panel at a low frequency when the still image is applied to the display panel, ii) the driving of the display panel at normal frequency when a first time elapses and iii) the driving of the display panel at a low frequency when a second time elapses.

The first time and the second time may have a one to one ratio.

The first time may be less than a minimum time at which an afterimage of the still image occurs when the still image is maintained on the display panel.

The signal for controlling the frequency of the display panel may be a scan start signal.

The signal control unit may control the driving of the display panel at a first frequency which is higher than a low driving frequency and lower than a normal driving frequency, prior to controlling the driving of the display panel at a normal frequency.

The signal control unit may control the driving of the display panel at a second frequency which is higher than the low driving frequency and lower than the normal driving frequency, after controlling the driving of the display panel at the normal frequency and prior to controlling the driving of the display panel at a low frequency again.

The second frequency may be higher than the first frequency.

The signal control unit may control the driving of the display panel at the normal frequency after the driving the display panel at a low frequency when the second time elapses when the first time elapses again.

The normal driving frequency may be about 60 Hz and the low frequency driving frequency may exceed 0 Hz and be less than about 60 Hz.

Another aspect is a driving method of a display device, including displaying a still image on a display panel, sensing, by a signal control unit, that a low frequency enable signal is high, driving the display panel at a low frequency, driving the display panel at a normal frequency when a first time elapses, and driving the display panel at a low frequency when a second time elapses.

The first time and the second time may have a one to one ratio.

The first time may be smaller than a minimum time at which an afterimage of the still image occurs when the still image is maintained on the display panel.

The signal control unit may control the frequency of the display panel, based on a frequency of a scan start signal.

The driving of the display panel at the normal frequency when the first time elapses may further include driving the display panel at a first frequency which is higher than a low driving frequency and lower than a normal driving frequency, prior to driving the display panel at the normal frequency.

The driving of the display panel at a low frequency when the second time elapses may further include driving the display panel at a second frequency which is higher than the low driving frequency and lower than the normal driving frequency, prior to driving the display panel at a low frequency.

The second frequency may be higher than the first frequency.

The driving of the display panel at a low frequency when the second time elapses may further include driving the display panel at a low frequency and then driving the display panel at a normal frequency again when the first time elapses again.

The normal driving frequency may be about 60 Hz and the low driving frequency may exceed 0 Hz and be less than about 60 Hz.

Another aspect is a display device, comprising: a display panel configured to display a still image and a moving image; and a signal controller configured to receive a low frequency enable signal, wherein the signal controller is further configured to supply signals for i) driving the display panel and ii) controlling a frequency of the display panel based at least in part on the low frequency enable signal, wherein, when the display panel displays the still image, the signal controller is further configured to i) drive the display panel at a low driving frequency, ii) drive the display panel at a normal driving frequency after a first time elapses, and iii) drive the display panel at the low driving frequency after a second time elapses.

In the above device, the lengths of the first and second times have a substantially one to one ratio. In the above device, the first time is less than a minimum time at which an afterimage of the still image occurs when the still image is maintained on the display panel. In the above device, the signal for controlling the frequency of the display panel comprises a scan start signal. In the above device, the signal controller is further configured to drive the display panel at a first driving frequency prior to driving the display panel at the normal driving frequency, and wherein the first driving frequency is higher than the low driving frequency and lower than the normal driving frequency.

In the above device, the signal controller is further configured to drive the display panel at a second driving frequency after driving the display panel at the normal driving frequency and prior to driving the display panel at the low driving frequency, wherein the second driving frequency is higher than the low driving frequency and lower than the normal driving frequency. In the above device, the second driving frequency is higher than the first driving frequency. In the above device, the signal controller is configured to, after driving the display panel at the low driving frequency, drive the display panel at the normal driving frequency after the first time elapses again. In the above device, the normal driving frequency is about 60 Hz and the low driving frequency is greater than 0 Hz and is less than about 60 Hz.

Another aspect is a method of driving a display device including a display panel, comprising: displaying a still image on the display panel; driving the display panel at a low driving frequency; driving the display panel at a normal driving frequency after a first time elapses; and driving the display panel at the low driving frequency after a second time elapses.

In the above method, the lengths of the first and second times have a substantially one to one ratio. In the above method, the first time is less than a minimum time at which an afterimage of the still image occurs when the still image is maintained on the display panel. In the above method, the display device further comprises a signal controller configured to supply a scanning start signal to control the frequency of the display panel.

In the above method, the driving of the display panel at the normal driving frequency includes: driving the display panel at a first driving frequency prior to driving the display panel at the normal driving frequency, wherein the first driving frequency is higher than the low driving frequency and lower than the normal driving frequency. In the above method, the driving of the display panel at the low driving frequency includes: driving the display panel at a second driving frequency prior to driving the display panel at the low driving frequency, wherein the second driving frequency is higher than the low driving frequency and lower than the normal driving frequency.

In the above method, the second driving frequency is higher than the first driving frequency. In the above method, the driving of the display panel at the low driving frequency includes: after driving the display panel at the low driving frequency, driving the display panel at the normal driving frequency again after the first time elapses again. In the above method, the normal driving frequency is about 60 Hz and the low driving frequency is greater than 0 Hz and is less than about 60 Hz. In the above method, the first time is a first predetermined time; and the second time is a second predetermined time. In the above method, the driving the display panel at a second driving frequency prior to driving the display panel at the low driving frequency is performed after driving the display panel at the normal driving frequency.

According to at least one embodiment, a liquid crystal display can prevent the generation of an afterimage during low frequency driving or reduce the luminance flickering phenomenon in a frequency change period, by inserting a normal driving period during the low power driving.

### BRIEF DESCRIPTION OF THE DRAWINGS

FIG. 1 is a block diagram of an LCD according to an exemplary embodiment.

FIG. 2 is an equivalent circuit diagram of one pixel in the LCD according to the exemplary embodiment.

FIG. 3 is a diagram illustrating LE, STV, and a frequency (Freq) of the STV according to an exemplary embodiment.

FIG. 4 is a diagram illustrating LE, STV, and a frequency (Freq) of the STV according to another exemplary embodiment.

FIG. 5 is a diagram illustrating a 7×7 mosaic pattern.

FIG. 6 is a table describing the time at which an afterimage appears according to the driving frequency when the 7×7 mosaic pattern is applied to a normal gray panel.

FIG. 7 is a diagram illustrating LE, STV, and a frequency (Freq) of the STV according to a Comparative Example.

### DETAILED DESCRIPTION OF CERTAIN INVENTIVE EMBODIMENTS

Generally, when a display panel displays a still image, the signal controller outputs the image data and power consumption may be increased since the panel, data driving unit, and gate driving unit all operate together to generate an image. In order to solve the above problems, a display panel may be driven with a low frequency when displaying a still image to reduce power consumption. However, when a low frequency is used, the display panel is vulnerable to an afterimage phenomenon and may also present a luminance flickering phenomenon which changes luminance when the display frequency is changed.

The described technology will be described more fully hereinafter with reference to the accompanying drawings, in which exemplary embodiments of the described technology are shown. As those skilled in the art would realize, the described embodiments may be modified in various different ways, all without departing from the spirit or scope of the described technology.

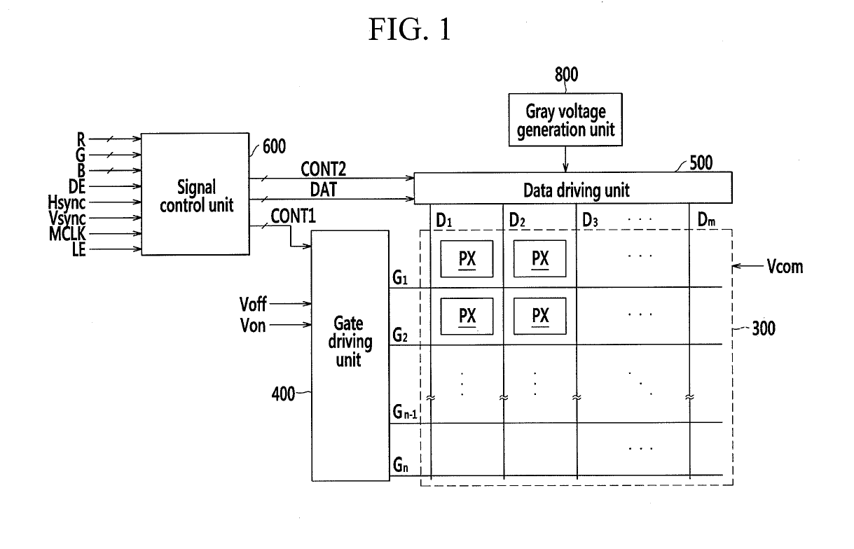

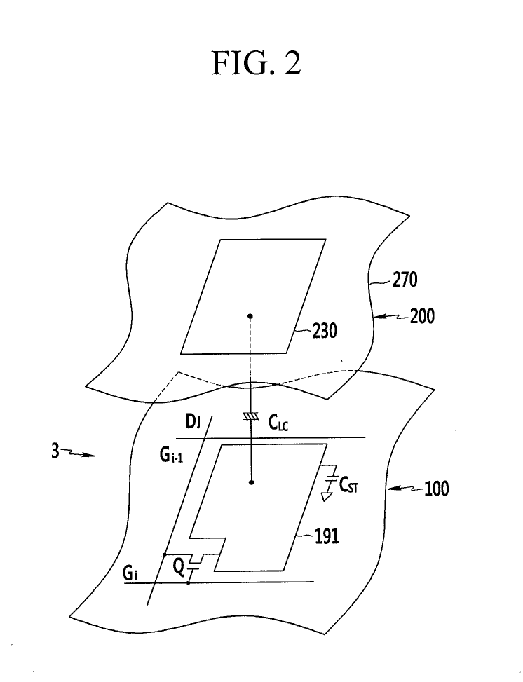

FIG. 1 is a block diagram of a liquid crystal display (LCD) according to an exemplary embodiment of the described technology and FIG. 2 is an equivalent circuit diagram of one pixel in the LCD according to the exemplary embodiment.

As illustrated in FIG. 1, the LCD according to the exemplary embodiment of the described technology includes a liquid crystal panel assembly 300, and a gate driving unit (hereinafter to be interchangeably used with a gate driver) 400 and a data driving unit (hereinafter to be interchangeably used with a data driver) 500 each connected to the crystal panel assembly 300. The LCD further includes a gray voltage generation unit (hereinafter to be interchangeably used with a gray voltage generator) 800 connected to the data driving unit 500, and a signal control unit (hereinafter to be interchangeably used with a signal controller) 600 controlling these components.

When viewed by an equivalent circuit, the liquid crystal panel assembly 300 includes a plurality of signal lines G1 to Gn and D1 to Dm and a plurality of pixels PXs connected thereto and arranged in substantially matrix pattern. Further, when viewing the structure illustrated in FIG. 2, the liquid crystal panel assembly 300 includes lower and upper panels 100 and 200 facing each other and a liquid crystal layer 3 interposed therebetween.

The signal lines G1 to Gn and D1 to Dm include a plurality of gate lines G1 to Gn that transfers gate signals (referred to as “scan signals”) and a plurality of data lines D1 to Dm that transfers data voltages. The gate lines G1 to Gn substantially extend in a row direction and are substantially parallel to each other and the data lines D1 to Dm substantially extend in a column direction and are substantially parallel to each other.

Each pixel PX, for example, a pixel PX connected to an i-th (i=1, 2, . . . , n) gate line Gi and a j-th (j=1, 2, . . . , m) data line Dj includes a switching element Q connected to the signal lines Gi and Dj and a liquid crystal capacitor Clc and a storage capacitor Cst connected thereto. The storage capacitor Cst may be omitted as required.

Referring to FIG. 2, the switching element Q is a three terminal element such as a thin film transistor included in the lower panel 100 and a control terminal thereof is connected to the gate line Gi, an input terminal thereof is connected to the data line Dj, and an output terminal thereof is connected to the liquid crystal capacitor Clc and the storage capacitor Cst. The thin film transistor may include polysilicon or amorphous silicon.

The liquid crystal capacitor Clc has a pixel electrode 191 in the lower panel 100 and a common electrode 270 in the upper panel 200 as two terminals and the liquid crystal layer 3 between the two electrodes 191 and 270 functions as a dielectric material. The pixel electrode 191 is connected to the switching element Q and the common electrode 270 is formed on a front surface of the upper panel 200 and is applied with common voltage Vcom. In contrast to FIG. 2, the common electrode 270 may be provided on the lower panel 100 and in this case, at least one of the two electrodes 191 and 270 may be formed in a line shape or a bar shape.

The storage capacitor Cst may perform an auxiliary role to the liquid crystal capacitor Clc and may be formed by superimposing a separate signal line (not illustrated) disposed on the lower display panel 100 with the pixel electrode 191, having an insulator disposed therebetween. The separate signal line may be applied with a defined voltage, such as the common voltage Vcom. Alternatively, the storage capacitor Cst may be formed by superimposing the pixel electrode 191 with a previous gate line, having an insulator disposed therebetween.

Meanwhile, in order to implement a color display, each pixel PX uniquely displays a primary color (spatial division) or each pixel PX alternately displays primary colors over time (temporal division), such that the desired colors may be recognized by the spatial and temporal sum of these primary colors. An example of the primary colors may include three primary colors, such as red, green, and blue. FIG. 2 illustrates a configuration where each pixel PX includes a color filter 230 representing one of the primary colors in a region of the upper panel 200 corresponding to the pixel electrode 191 as an example of spatial division. That is, the three pixels PXs each representing red, green, and blue form one dot, and together, represent one color. In contrast to FIG. 2, the color filter 230 may be disposed above or under the pixel electrode 191 of the lower panel 100.

An outer surface of the liquid crystal panel assembly 300 may have at least one polarizer (not illustrated) which polarizes light attached thereto.

Referring back to FIG. 1, the gray voltage generation unit 800 generates two sets of gray voltages which are associated with the transmittance of the pixels PX. One of the two sets of gray voltages has a positive value with respect to the common voltage Vcom and the other of the two sets has a negative value. The number of gray voltages included in the gray voltages generated by the gray voltage generation unit 800 may be the same as the number of grays levels which may be displayed by the LCD.

The data driving unit 500 is connected to the data lines D1 to Dm of the liquid crystal panel assembly 300 and selects a gray voltage from the gray voltage generation unit 800 and applies the gray voltage to the data lines D1 to Dm as the data voltage.

The gate driving unit 400 applies gate signals configured of a combination of a gate-on voltage Von and a gate-off voltage Voff to the gate lines G1 to Gn.

The driving devices 400, 500, 600, and 800 may each be integrated in the liquid crystal panel assembly 300, together with the signal lines G1 to Gn and D1 to Dm and the switching elements Q. Alternatively, the driving devices 400, 500, 600, and 800 may be directly mounted on the liquid crystal panel assembly 300 in the form of at least one IC chip, mounted on a flexible printed circuit film (not illustrated) to be attached to the liquid crystal panel assembly 300 in a tape carrier package (TCP), or mounted on a separate printed circuit board (PCB) (not illustrated). Further, the driving devices 400, 500, 600, and 800 may be integrated in a single chip and in this case, at least one device among the driving devices 400, 500, 600, and 800 or at least one circuit element forming a portion of at least one of the driving devices 400, 500, 600, and 800 may be present outside the single chip.

Next, the operation of the LCD will be described in detail.

The signal control unit 600 receives input image signals R, G, and B and an input control signal controlling a display thereof from an external graphic controller (not illustrated). The input image signals R, G, and B include luminance information of each pixel PX and the luminance has a defined value, for example, the value may be a gray level from among 1024 (=2¹⁰), 256 (=2⁸) or 64 (=2⁶) gray levels. An example of the input control signal may include a vertical synchronization signal Vsync, a horizontal synchronization signal Hsync, a main clock MCLK, a data enable signal DE, a low frequency enable signal (LE), and the like.

According to the present exemplary embodiment, the low frequency enable signal (LE) has a high state when the LCD displays a still image. Further, the low frequency enable signal (LE) has a low state when the LCD displays a moving image. The signal control unit 600 generates an output image signal DAT based on the input image signals R, G, and B and the input control signal and appropriately processes them and generates a gate control signal CONT1, a data control signal CONT2, and the like. Next, the signal control unit 600 transmits the gate control signal CONT1 to the gate driving unit 400 and transmits the data control signal CONT2 and the processed output image signal DAT to the data driving unit 500.

The gate control signal CONT1 includes a scan start signal STV instructing a scan start and at least one clock signal controlling an output period of the gate-on voltage Von. The gate control signal CONT1 may further include an output enable signal OE which limits the duration of the gate-on voltage Von.

The signal control unit 600 may control the display panel frequency. According to the present exemplary embodiment, the signal control unit 600 may control the display panel frequency based on the LE or the DE. The display panel frequency is the frequency at which the display panel of the LCD is operated.

The signal control unit 600 may control the frequency of the gate control signal CONT1 or the data control signal CONT2. According to the present exemplary embodiment, the display panel frequency may depend on the frequency of the gate control signal CONT1 or the data control signal CONT2. In particular, the signal control unit 600 may control the frequency of the scan start signal STV or a horizontal synchronization start signal STH. Hereinafter, the case in which the signal control unit 600 controls the scan start signal STV will be described by way of example. Further, the following description may also be applied to the scan start signal STV, the gate control signal CONT1, the data control signal CONT2, and the horizontal synchronization start signal STH.

According to the present exemplary embodiment, the signal control unit 600 controls the scan start signal STV based on the low frequency enable signal (LE). The signal control unit 600 drives the scan start signal STV at a low frequency when the low frequency enable signal LE is high. The signal control unit 600 drives the scan start signal STV normally when the low frequency enable signal LE is low. The driving of the scan start signal STV will be described below in detail.

The data control signal CONT2 may include the horizontal synchronization start signal STH indicating the transmission start of the output image signal DAT for a bundle of pixels PXs and a load signal LOAD and a data clock signal HCLK instructing the application of data voltages to the liquid crystal panel assembly 300. The data control signal CONT2 may further include an inversion signal RVS which inverts the voltage polarity of the data voltage with respect to the common voltage Vcom (hereinafter, referred to as “polarity of the data signal” which is short for “voltage polarity of the data signal with respect to the common voltage”).

When the frequency of the gate control signal CONT1 is changed, the frequency of the data control signal CONT2 may also be changed. According to the present exemplary embodiment, as the frequency of the scan start signal STV is changed, the signal control unit 600 may control a change in the frequency of the data control signal CONT2. That is, when the frequency of the gate control signal CONT1, such as the scan start signal STV, decreases, the frequency of the data control signal CONT2 may also decrease. Further, when the frequency of the gate control signal CONT1, such as the scan start signal STV, increases, the frequency of the data control signal CONT2 may also increase.

The data driving unit 500 receives the digital output image signal DAT for a bundle of pixels PX depending on the data control signal CONT2 received from the signal control unit 600 and selects a gray voltage corresponding to each digital output image signal DAT to convert the digital output image signal DAT into analog data voltage, which is in turn applied to the corresponding data lines D1 to Dm.

The gate driving unit 400 applies the gate-on voltage Von to the gate lines G1 to Gn depending on the gate control signal CONT1 received from the signal control unit 600 to turn on the switching element Q connected to the gate lines G1 to Gn. Next, the data voltage applied to the data lines D1 to Dm is applied to the corresponding pixel PX through the turned-on switching element Q.

The difference between the data voltage applied to the pixel PX and the common voltage Vcom is applied as a charging voltage in the liquid crystal capacitor Clc, that is, a pixel voltage. Liquid crystal molecules have an arrangement which varies depending on the magnitude of the pixel voltage, which may cause a change in the polarization of light transmitted through the liquid crystal layer 3. The change in polarization appears as a change in transmittance of light due to the polarizer attached to the display panel assembly 300, such that the pixel PX displays luminance represented by the gray level of the image signal DAT.

By repeating the process based on 1 horizontal period [written by “1H” which is the same as one period of a horizontal synchronization signal Hsync and the data enable signal DE] as a unit, the gate-on voltage Von is sequentially applied to all the gate lines G1 to Gn and the data voltage is applied to all the pixels PXs to display an image of one frame.

A next frame starts after one frame ends and the state of an inversion signal RVS applied to the data driving unit 500 is controlled so that the polarity of the data voltage applied to each pixel PX is opposite to the polarity of the data voltage of a previous frame (also referred to as “frame inversion”). In this case, the polarity of the data voltage flowing through one data line may be changed (for example: row inversion, dot inversion) depending on characteristics of the inversion signal RVS even within one frame or the polarity of the data voltage applied to one pixel row may be different (for example: column inversion, dot inversion).

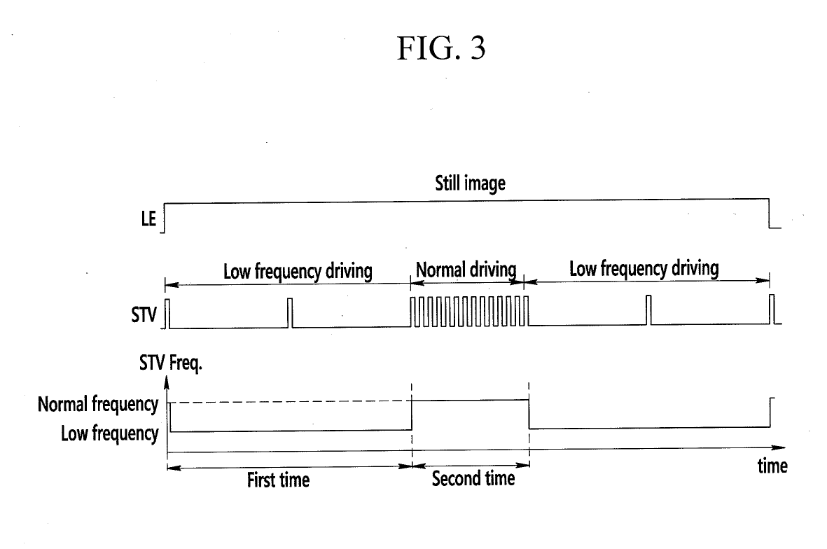

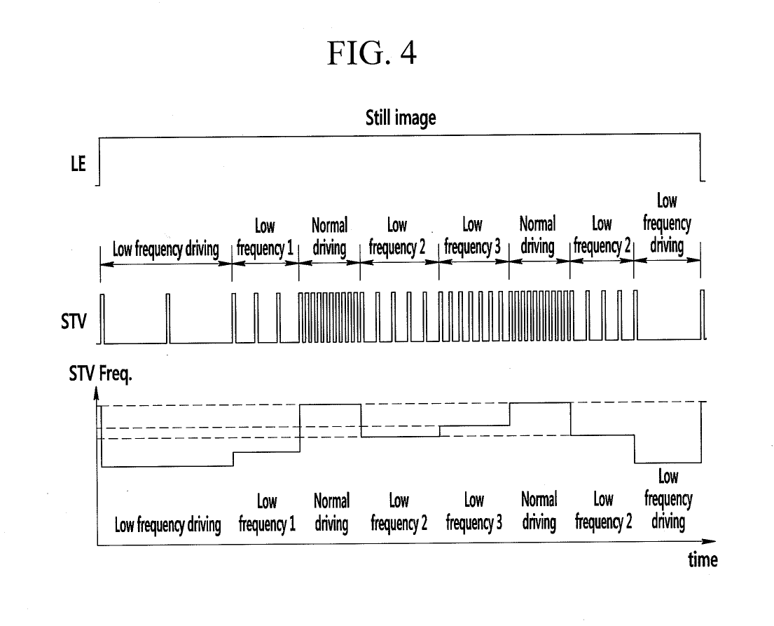

Next, referring to FIGS. 3 and 4, the driving of the scan start signal STV according to the present exemplary embodiment will be described.

FIG. 3 is a diagram illustrating LE, STV, and a frequency (Freq) of the STV according to an exemplary embodiment.

According to the present exemplary embodiment, the scan start signal STV may include a low frequency driving period or a normal driving period when the LE is high. According to the exemplary embodiment, the LCD displays a still image when the LE is high and displays a moving image when the LE is low. The scan start signal STV has a lower frequency in the low frequency driving period than in the normal driving period. According to the present exemplary embodiment, the frequency of the scan start signal STV may be about 60 Hz in the normal driving period. Further, the frequency of the scan start signal STV may exceed 0 Hz and be less than about 60 Hz in the low frequency driving period. According to the present exemplary embodiment, the frequency of the scan start signal STV may be about 10 Hz in the low frequency driving period. According to some embodiments, the frequency of the scan start signal STV may be greater than about 60 Hz in the normal driving period and the frequency of the scan start signal STV may be greater than 0 Hz and less than the frequency of the normal driving period in the low frequency driving period.

The signal control unit 600 controls the driving of the STV at a low frequency when the LE is changed from low to high. Next, the signal control unit 600 may control the normal driving of the STV after a first time elapses. According to the present exemplary embodiment, the first time may be defined in advance. Further, the first time may also be determined by experiment. Next, the signal control unit 600 may control the driving of the STV at a low frequency after a second time elapses. According to the present exemplary embodiment, the second time may also be defined in advance. The second time may also be determined by experiment. According to the present exemplary embodiment, the lengths of the first and second times may have a substantially one to one ratio.

According to another exemplary embodiment, the second time may also be determined depending on the still image. In other words, the second time may also be long as the still image is vulnerable to an afterimage.

In FIG. 3, the STV has two low frequency driving periods and one normal driving period while the LCD displays a still image, but is not limited thereto. According to the present exemplary embodiment, the STV may also have more normal driving periods while the LCD displays a still image.

According to the present exemplary embodiment, when the input of the LE to the signal control unit 600 stops, the signal control unit 600 controls the driving to be performed at a normal frequency.

FIG. 4 is a diagram illustrating LE, STV, and a frequency (Freq) of the STV according to another exemplary embodiment.

According to the exemplary embodiment illustrated in FIG. 4, the scan start signal STV may include a low frequency driving period, a low frequency 1 driving period, a low frequency 2 driving period, a low frequency 3 driving period, or a normal driving period while the LE is applied to the signal control unit 600. The scan start signal STV has a lower frequency in the low frequency driving period, the low frequency 1 driving period, the low frequency 2 driving period, and the low frequency 3 driving period than in the normal driving period. In FIG. 4, a total of four low frequency driving periods are illustrated, but the described technology is not necessarily limited thereto. According to the present exemplary embodiment, the STV may have more or less low frequency driving periods or normal driving periods than illustrated in FIG. 4.

According to the present exemplary embodiment, the scan start signal STV may include the low frequency 1 driving period having a lower frequency than in the normal driving period, before the normal driving period. Further, the scan start signal STV may also include the low frequency 2 driving period having a lower frequency than in the normal driving period, after the normal driving period. The low frequency 1 driving period may also have a lower frequency than the low frequency 2 driving period. The scan start signal STV may also have at least one normal driving period. In the case in which the scan start signal STV has at least one normal driving period, the scan start signal STV may also have the low frequency 3 driving period, before a second normal driving period starts. The frequency of the low frequency 3 driving period may be higher than the frequency of the low frequency driving period and lower than the frequency of the normal driving period. The frequency of the low frequency 3 driving period may also be higher than the frequency of the low frequency 2 driving period. According to the present exemplary embodiment, after the second normal driving period ends, the scan start signal STV may also have a driving period having a frequency less than the frequency of the normal driving period and larger than the frequency of the low frequency driving period. The scan start signal STV may also have the low frequency 2 driving period after the second normal driving period ends.

According to the present exemplary embodiment, the frequency of the scan start signal STV may be about 60 Hz in the normal driving period. Further, the frequency of the scan start signal STV may be about 10 Hz in the low frequency driving period, about 20 Hz in the low frequency 1 driving period, about 30 Hz in the low frequency 2 driving period, and about 40 Hz in the low frequency 3 driving period. However, the frequencies of the respective driving periods are not limited to those described in the present exemplary embodiment and may be varied according to the design requirements of the display device.

When the frequency of the scan start signal STV is suddenly changed, a luminance flickering phenomenon may occur in the LCD. Therefore, in order to prevent the flickering, when the frequency is changed from the low frequency driving period to the normal driving period or is changed from the normal driving period to the low frequency driving period, the signal control unit 600 may initiate a driving period having a frequency between the frequencies of the normal driving period and the low frequency driving period so as to gradually change the frequency of the STV.

According to the present exemplary embodiment, when the input of the LE to the signal control unit 600 stops, the signal control unit 600 controls the STV to have the normal driving period.

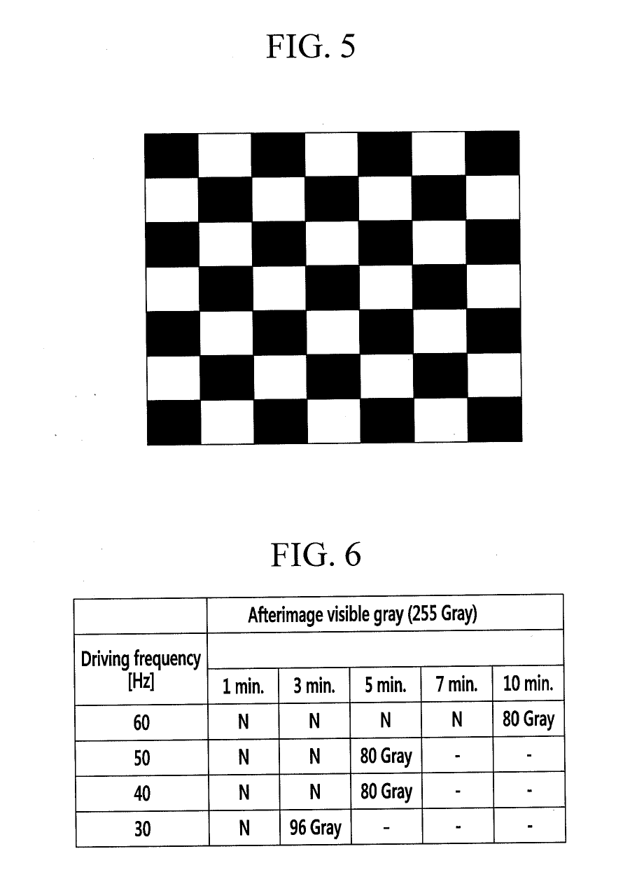

Next, the afterimage phenomenon of an LCD will be described with reference to FIGS. 5 to 7.

FIG. 5 is a diagram illustrating a 7×7 mosaic pattern.

FIG. 6 is a table describing the times at which an afterimage appears according to a driving frequency when the 7×7 mosaic pattern is applied to a normal gray panel.

Referring to the table illustrated in FIG. 6, when the 7×7 mosaic pattern (hereinafter, referred to as a pattern) is applied to the normal gray panel having a driving frequency of 60 Hz for 10 minutes, an afterimage of 80 gray appears.

Further, when the pattern is applied to a normal gray panel having a driving frequency of 50 Hz for 5 minutes, an afterimage of 80 gray appears.

Further, when the pattern is applied to a normal gray panel having a driving frequency of 40 Hz for 5 minutes, an afterimage of 80 gray appears.

Further, when the pattern is applied to a normal gray panel having a driving frequency of 30 Hz for 3 minutes, an afterimage of 96 gray appears.

According to the table illustrated in FIG. 6, when the still image is continuously applied to the panel, it can be understood that an afterimage more rapidly appears as the panel is driven at lower frequencies. Therefore, low frequency driving is more vulnerable to afterimages.

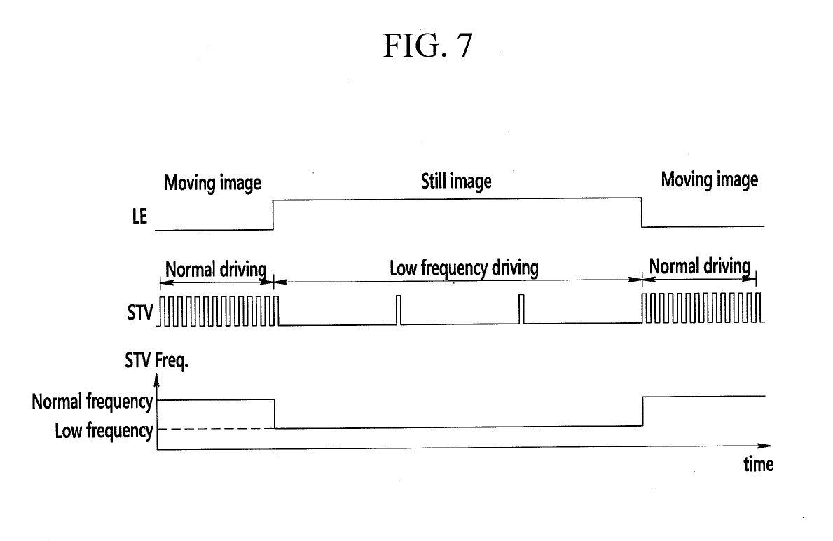

FIG. 7 is a diagram illustrating a scan start signal STV and a frequency (Freq) of the STV according to a Comparative Example.

According to the Comparative Example, the scan start signal STV has only the low frequency driving period while the LE is applied to the signal control unit 600. As described above, low frequency driving periods may be vulnerable to an afterimage. In particular, according to the Comparative Example, since the scan start signal STV has only the low frequency driving period while the LE is applied, the panel of the LCD is vulnerable to an afterimage of the still image.

Referring back to FIGS. 3 and 4, in order for the LCD to withstand the afterimage of the still image, the signal control unit 600 controls the STV to include a normal driving period while the STV has a low frequency driving period for a predetermined time while the LE is applied. When the same still image is applied to the panel, in the frequency of the low frequency driving period, the predetermined time needs to be set smaller than the minimum time at which an afterimage occurs.

While the described technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a display panel configured to display a still image and a moving image; and
a signal controller configured to receive a low frequency enable signal, wherein the signal controller is further configured to supply signals for i) driving the display panel and ii) controlling a frequency of the display panel based at least in part on the low frequency enable signal,
wherein, when the display panel displays the still image, the signal controller is further configured to i) drive the display panel at a low driving frequency, ii) drive the display panel at a normal driving frequency after a first time elapses, and iii) drive the display panel at the low driving frequency after a second time elapses.

2. The display device of claim 1, wherein the lengths of the first and second times have a substantially one to one ratio.

3. The display device of claim 1, wherein the first time is less than a minimum time at which an afterimage of the still image occurs when the still image is maintained on the display panel.

4. The display device of claim 1, wherein the signal for controlling the frequency of the display panel comprises a scan start signal.

5. The display device of claim 1, wherein the signal controller is further configured to drive the display panel at a first driving frequency prior to driving the display panel at the normal driving frequency, and wherein the first driving frequency is higher than the low driving frequency and lower than the normal driving frequency.

6. The display device of claim 5, wherein the signal controller is further configured to drive the display panel at a second driving frequency after driving the display panel at the normal driving frequency and prior to driving the display panel at the low driving frequency, wherein the second driving frequency is higher than the low driving frequency and lower than the normal driving frequency.

7. The display device of claim 6, wherein the second driving frequency is higher than the first driving frequency.

8. The display device of claim 1, wherein the signal controller is configured to, after driving the display panel at the low driving frequency, drive the display panel at the normal driving frequency after the first time elapses again.

9. The display device of claim 1, wherein the normal driving frequency is about 60 Hz and the low driving frequency is greater than 0 Hz and is less than about 60 Hz.

10. A method of driving a display device including a display panel, comprising:
displaying a still image on the display panel;
driving the display panel at a low driving frequency;
driving the display panel at a normal driving frequency after a first time elapses; and
driving the display panel at the low driving frequency after a second time elapses.

11. The driving method of claim 10, wherein the lengths of the first and second times have a substantially one to one ratio.

12. The method of claim 10, wherein the first time is less than a minimum time at which an afterimage of the still image occurs when the still image is maintained on the display panel.

13. The method of claim 10, wherein the display device further comprises a signal controller configured to supply a scanning start signal to control the frequency of the display panel.

14. The method of claim 10, wherein the driving of the display panel at the normal driving frequency includes:
driving the display panel at a first driving frequency prior to driving the display panel at the normal driving frequency,
wherein the first driving frequency is higher than the low driving frequency and lower than the normal driving frequency.

15. The method of claim 14, wherein the driving of the display panel at the low driving frequency includes:
driving the display panel at a second driving frequency prior to driving the display panel at the low driving frequency,
wherein the second driving frequency is higher than the low driving frequency and lower than the normal driving frequency.

16. The method of claim 15, wherein the second driving frequency is higher than the first driving frequency.

17. The method of claim 10, wherein the driving of the display panel at the low driving frequency includes:
after driving the display panel at the low driving frequency, driving the display panel at the normal driving frequency again after the first time elapses again.

18. The method of claim 10, wherein the normal driving frequency is about 60 Hz and the low driving frequency is greater than 0 Hz and is less than about 60 Hz.

19. The method of claim 10, wherein the first time is a first predetermined time; and the second time is a second predetermined time.

20. The method of claim 15, wherein the driving the display panel at a second driving frequency prior to driving the display panel at the low driving frequency is performed after driving the display panel at the normal driving frequency.
